(19) United States
(12) Patent Application Publication
(10) Pub. No.: US 2018/0327691 A1
(43) Pub. Date: Nov. 15, 2018

(54) Laundry Composition and Method of Making it

(71) Applicant: Reckitt Benckiser Vanish B.V., Hoofddorp (NL)

(72) Inventors: Anna CRESTANA, Mira (IT); Remigio MUSCI, Mira (IT)

(73) Assignee: Reckitt Benckiser Vanish B.V., Hoofdorp (NL)

(21) Appl. No.: 15/775,527

(22) PCT Filed: Oct. 5, 2016
(86) PCT No.: PCT/GB2016/053096

§ 371 Date: May 11, 2018

(30) Foreign Application Priority Data
Nov. 16, 2015 (GB) 1520125.4

(51) Int. Cl. C11D 1/83; C11D 3/22; C11D 11/00

(52) U.S. Cl. CPC C11D 1/83; C11D 11/0017; C11D 11/0088; C11D 3/225

(57) ABSTRACT

A laundry composition comprises:-
a) from 2 wt % to 10 wt % anionic soap surfactant,
b) from 0.5 wt % to 2.5 wt % alkyl sulphate,
c) from 0.1 wt % to 2 wt % nonionic surfactant,
d) from 0.1 wt % to 2 wt % carboxy methyl cellulose,
e) from 2 wt % to 12 wt % source of active oxygen.

The present invention relates to a cleaning composition.

Laundry cleaning products are extremely well known. Usually a composition in the form of a liquid or powder is added to a laundry washing machine, either directly to the drum or via a dispenser, and washing is carried out using an appropriate selection from a number of pre-programmed cycles.

Laundry powders are typically made by forming a slurry of the powder components, which is processed in a spray tower to be dried into a powder. On significant issue with this is that control of the viscosity is crucial (and difficult) to ensure that adequate/accurate slurry dosing is achieved to bring about effective and controlled powder formation.

We have now found that with the use of the inventive composition highly advantageous tower powder processing is achieved.

According to a first aspect of the invention there is provided a laundry composition comprising:-

a) from 2 wt % to 10 wt % anionic soap surfactant,

b) from 0.5 wt % to 2.5 wt % alkyl sulphate,

c) from 0.1 wt % to 2 wt % nonionic surfactant,

d) from 0.1 wt % to 2 wt % carboxy methyl cellulose,

e) from 2 wt % to 12 wt % source of active oxygen.

By the use of this formulation it has been found that it is feasible to produce a un-classified formulation with standard production equipment.

According to a second aspect of the invention there is provided a method of preparing a laundry composition according to the first aspect of the invention comprising:
I. forming a slurry of certain elements of the composition;
II. feeding the slurry to a tower spray apparatus; and
III. optionally (post) adding of elements of the comspprion;

wherein the slurry formation comprises the following composition:
a) water (preferably present in an amount of about 32 wt %)
b) anionic soap surfactant (preferably present in an amount of about 5.5 wt %)
c) a filler, such as sodium sulfate (preferably present in an amount of about 45 wt %);
d) zeolite (preferably present in an amount of about 20 wt %);
e) polymer, e.g. copolymer (preferably present in an amount of about 5.5 wt %);

wherein the pH during mixing is maintained below 8.5 (adding alkali, such as NaOH, as required) and wherein the working temperature is maintained between 50° C.-60° C. during the mixing.

Preferably the components (a) to (e) are added to the slurry preparation vessel in the order (a) to (e) respectively.

By changing the order of addition of some of the ingredients of the slurry and by carefully monitoring the pH of the bulk surprisingly, the slurry remains at a far lower viscosity vs a standard process. The slurry can be easily mixed and pumped. Conversely with a “standard order” of addition, the slurry dramatically increase its viscosity and become un-processable with standard equipment.

Anionic soap surfactants represent the primary detergent component in the present compositions of interest. This class of surfactants includes ordinary alkali metal soaps such as the sodium, potassium, ammonium and alkanol-ammonium salts of higher fatty acids containing from about 8 to about 24 carbon atoms and preferably from about 10 to about 20 carbon atoms. Suitable fatty acids can be obtained from natural sources such as, for instance, plant or animal esters (e.g., palm oil, coconut oil, babassu oil, soybean oil, castor oil, tallow, whale and fish oils, grease, lard, and mixtures thereof). The fatty acids also can be synthetically prepared (e.g., by the oxidation of petroleum, or by the Fischer-Tropsch process). Resin acids are suitable such as rosin and those resin acids in tall oil. Naphthenic acids are also suitable. Sodium and potassium soaps can be made by direct saponification of the fats and oils or by the neutralization of the free fatty acids which are prepared in a separate manufacturing process. Particularly useful is the sodium or potassium salt of the mixtures of fatty acids derived from castor oil, i.e., sodium castor oil soap. The anionic soap surfactant in the present invention comprises an amount from about 0.1 to about 20 wt percent, preferably from about 4 to about 8 wt percent, and more preferably from about 6 wt percent.

The alkyl sulphate used in the present invention may be monoalkyl sulphuric acid esters derived from fatty alcohols which are well-known for use as a tenside. Because of its especially good foaming behavior, lauryl sulphate is preferred. The alkyl sulphate in the present invention comprises an amount of about 1.5 wt percent.

The nonionic surfactant is preferably a surfactant having a formula RO(CH₂CH₂O)ₙH wherein R is a mixture of linear, even carbon-number hydrocarbon chains ranging from Ci₂H₂5 to Ci₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide per mole of alcohol (i.e. equivalents).

Other examples of nonionic surfactants include primary alcohol ethoxylates (available under the Neodol tradename from Shell Co.), such as Cu alkanol condensed with 9 equivalents of ethylene oxide (Neodol 1-9), C12-13 alkanol condensed with 6.5 equivalents ethylene oxide (Neodol 23-6.5), C₁₂-₁₃ alkanol with 9 equivalents of ethylene oxide (Neodol 23-9), C₁₂-₁₅ alkanol condensed with 7 or 3 equiva-lents ethylene oxide (Neodol 25-7 or Neodol 25-3), C14-15 alkanol condensed with 13 equivalents ethylene oxide (Neodol 45-13), C₉-₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configura-tion condensed with 5 to 30 equivalents of ethylene oxide. Examples of commercially available non-ionic detergents of the foregoing type are Cn-₁₅ secondary alkanol condensed with either 9 equivalents of ethylene oxide (Tergitol 15-S-9) or 12 equivalents of ethylene oxide (Tergitol 15-S-12) marketed by Union Carbide, a subsidiary of Dow Chemical.

Octylphenoxy polyethoxyethanol type nonionic surfactants, for example, Triton X-IOO, as well as amine oxides can also be used as a nonionic surfactant in the present invention.

Other examples of linear primary alcohol ethoxylates are available under the Tomadol tradename such as, for example, Tomadol 1-7, a Cu linear primary alcohol ethoxylate with 7 equivalents EO; Tomadol 25-7, a C₁₂-₁₅ linear primary alcohol ethoxylate with 7 equivalents EO; Tomadol 45-7, a C14-15?n-ear primary alcohol ethoxylate with 7 equivalents EO; and Tomadol 91-6, a C₉-n linear alcohol ethoxylate with 6 equivalents EO.

Other nonionic surfactants are amine oxides, alkyl amide oxide surfactants.

The nonionic surfactant in the present invention comprises an amount of about 1 wt percent.

The CMC in the present invention comprises an amount of about 1 wt percent.

An essential ingredient is a source of active oxygen. A preferred source according to the present invention is hydrogen peroxide or sources thereof. As used herein a hydrogen peroxide source refers to any water-soluble source of hydrogen peroxide. Suitable water-soluble sources of hydrogen peroxide for use herein include percarbonates, organic or inorganic peroxides and perborates. Preferably, sodium percarbonate is used.

Preferably, the source of active oxygen provides about 7 percent w/w of the total composition.

As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources according to the present invention increase the ability of the compositions to remove oxidisable stains, to destroy malodorous molecules and to kill germs.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof.

Suitable preformed peroxyacids for use in the compositions according to the present invention include diperoxydodecandioic acid DPDA, magnesium perphthalatic acid, perlauric acid, perbenzoic acid, diperoxyazelaic acid and mixtures thereof.

Optionally, the compositions may additionally comprise from 0.1 percent to 40 percent w/w, preferably from 1 percent to 10 percent w/w, ideally 1 percent to 10 percent w/w of peracid precursors, i.e. compounds that upon reaction with hydrogen peroxide product peroxyacids. • Examples of peracid precursors suitable for use in the present invention can be found among the classes of anhydrides, amides, imides and esters such as acetyl triethyl citrate (ATC) described for instance in EP 91 87 0207, tetra acetyl ethylene diamine (TAED), succinic or maleic anhydrides.

The composition may optionally contain a filler. Suitable fillers include bicarbonates and carbonates of metals, such as alkali metals and alkaline earth metals. Examples include sodium carbonate, sodium bicarbonate, calcium carbonate, calcium bicarbonate, magnesium carbonate, magnesium bicarbonate and sesqui-carbonates of sodium, calcium and/or magnesium. Other examples include metal carboxy glycine and metal glycine carbonate. Chlorides, such as sodium chloride; citrates; and sulfates, such as sodium sulfate, calcium sulfate and magnesium sulfate, may also be em-ployed.

The filler may be present in an amount of 0.1 to 80 percent wt, preferably 1 to 60 percent wt.

The composition may optionally contain a zeolite, but this is not essential. When zeolite is present, the zeolite preferably provides 4-30 percent, more preferably 6-20 percent, of the cleaning agent (weight/weight). Preferably, when there is a further input (post addition) of zeolite it is preferably less than the input of zeolite from the zeolite powder added to the tower spray powder.

Any suitable soil catcher may be employed. Unlike deter-gents or surfactants, which simply aid in the removal of soils from surfaces, the soil catcher actively binds to the soil allowing it to be removed from the surface of the laundry. Once bound, the soil is less likely to be able to redeposit onto the surface of the laundry. Preferred soil catchers have a high affinity to both oily and water-soluble soil. Preferably, the soil catcher is a mixture of two or more soil catchers, each soil catcher may have a different affinity for different soils. Preferred soil catchers for oily soils have a non polar structure with high absorption capability. Preferred water based soil catchers are generally charged and have a high surface area in order to attract the soil by electrostatic charge and collect it.

Suitable soil catchers include polymers, such as acrylic polymers, polyesters and polyvinylpyrrolidone (PVP). The polymers may be crosslinked, examples of which include crosslinked acrylic polymers and crosslinked PVP. Super absorbing polymers are mainly acrylic polymers and they are useful for the scope of this patent.

Other important polymers are ethylidene norbene polymers, ethylidene norbene/ethylene copolymers, ethylidene nor-bene/propylene/ethylidene ter-polymers. Inorganic materials may also be employed. Examples include silica, silicates (e.g. magnesium silicate), zeolites, talc, bentonites and active carbon. The latter may be used to absorb and/or degrade coloured parts of stain and/or absorb odours. Alginates, carrageneans and chitosan may also be used. Preferred water insoluble agents are selected from at least one of acrylic polymer, polyester, polyvinylpyrrolidone (PVP), silica, silicate, zeolite, talc, bentonites, active carbon, alginates, carrageneans, ethylidene raor-bene/propylene/ethylidene ter-polymers and chitosan in the manufacture of a cleaning composition as an active agent for binding soil. Preferably the cleaning composition is a laundry cleaning composition or stain-removing composition.

Preferably, the water-insoluble soil catcher compound would comprise a solid cross-linked polyvinyl N-oxide, or chitosan product or ethylidene norbene/propylene/ethylidene ter-polymers or blend of the same, as discussed more fully hereafter. Products made in accordance with the present invention which are suitable for use individually can be provided in a variety forms, but will at least contain a compartment for storing a water-insoluble soil catcher compound and have a plurality of apertures, as previously de-scribed.

Soil catcher compounds can deliver the soil catcher benefit by a variety of techniques, including, but not lim-ited to trapping the soil in such a manner that it is unavailable for re-deposition onto a fabric, precipitating out the soil or adsorbing, absorbing or otherwise becoming associated with any extraneous soil in the wash water.

As used herein, the phrase “substantially water insoluble” is intended to mean that the soil catcher compound has a solubility in deionised water at 20 degrees centigrade of less than about 1 gm/litre. A substantially water insoluble soil catcher compound may comprise a water-soluble soil catcher agent which is bound to a water insoluble carrier, or it may comprise a soil catcher agent which in itself is water insoluble. Water insoluble carriers for water-soluble polymeric agents include inorganic materials such as zeolites, clays such as kaolinites, smectites, hectorite types, silicas (or other detergent ingredients). Additionally, organic water-insoluble materials such as fatty alcohols, esters of fatty acids, or polysaccharides that can form water-insoluble gels upon hydration (e.g. gellan gum, carrageenan gum, aga-rose etc.) can be used as carriers herein. For the soil catcher agents which are themselves water soluble, water insolubility can be achieved by cross-linking, either starting from the known water-soluble soil catcher polymeric agents, or starting from monomers of these polymers. Other compounds that are suitable as water insoluble soil catcher agents are any compound exhibiting ion exchange properties, preferably anion exchangers. For instance, non-limiting examples of such products are Dowex(R) exchange resins of the Dow Chemical Co. or equivalent from other suppliers; Sephadex(R), Sepharose(R) or Sephacel (R) exchange resins all from Pharmacia Biotech; any other polysaccharide having ion exchange properties such as modified cellulosics, starches; other derivatives of the wood industry such as wood pulp or lignin.

Water soluble polymeric soil catcher agents that are suit-able to be bound to insoluble carriers, or to be made insoluble via cross-linking are those polymers known in the art to inhibit the transfer of dyes from coloured fabrics onto fabrics washed therewith. These polymers have the ability to complex or adsorb the fugitive dyes washed out of dyed fabrics before the dyes have the opportunity to become attached to other articles in the wash. Especially suitable polymeric soil catcher agents are polyamine N-oxide polymers, polymers and copolymers of N-vinylpyrrolidone and N-vinylimidazole, vinyloxazolidones, vinylpyridine, vinylpyridine N-oxide, other vinylpyridine derivatives or mixtures thereof. a) Polyamine N-Oxide Polymers

Suitable polyamine N-oxides wherein the N-O group forms part of the polymerisable unit comprise polyamine N-oxides wherein R is selected from aliphatic, aromatic, alicyclic or heterocyclic groups. One class of said polyamine N-oxides comprises the group of polyamine N-oxides wherein the nitrogen of the N-O group forms part of the R-group. Preferred polyamine N-oxides are those wherein R is a heterocyclic group such as pyridine, pyrrole, imidazole, pyrrolidine, piperidine, quinoline, acridine and derivatives thereof. Another class of said polyamine N-oxides comprises the group of polyamine N-oxides wherein the nitrogen of the N-O group is attached to the R-group. Other suitable polyamine N-oxides are the polyamine oxides wherein the N-O group is attached to the polymerisable unit. Preferred classes of these polyamine N-oxides are the poly-amine N-oxides having the general formula above wherein R is an aromatic, heterocyclic or alicyclic groups wherein the nitrogen of the N-O functional group is part of said R group. Examples of these classes are polyamine oxides wherein R is a heterocyclic compound such as pyridine, pyrrole, imidazole and derivatives thereof. Another preferred class of polyamine N-oxides is the polyamine oxides having the general formula above wherein R are aromatic, heterocyclic or alicyclic groups wherein the nitrogen of the N-O functional group is attached to said R groups. Examples of these classes are polyamine oxides wherein R groups can be aromatic such as phenyl.

Any polymer backbone can be used as long as the amine oxide polymer formed has soil catcher properties. Examples of suitable polymeric backbones are polyvinyls, polyalkylenes, polyesters, polyethers, polyamide, polyimides, polyacry-lates and mixtures thereof. The amine N-oxide polymers of the present invention typically have a ratio of amine to the amine N-oxide of about 10:1 to about 1:1000000. However the amount of amine oxide groups present in the polyamine oxide polymer can be varied by appropriate copolymerisation or by appropriate degree of N-oxidation. Preferably, the ratio of amine to amine N-oxide is from about 2:3 to about 1:1000000. More preferably from about 1:4 to about 1:1000000, and most preferably from about 1:7 to about 1:1000000. The polymers of the present invention may encompass random or block copolymers where one monomer type is an amine N-oxide and the other monomer type is either an amine N-oxide or not. The amine oxide unit of the polyamine N-oxides has a pKa less than 10, preferably pKa less than 7, more preferred pKa less than 6. The polyamine oxides can be obtained in almost any degree of polymerisation. The degree of polymeri-sation is not critical provided the material has the desired dye-suspending power. Typically, the average molecular weight is within the range of about 500 to about 1,000,000; preferably from about 1,000 to about 50,000, more preferably from about 2,000 to about 30,000, and most preferably from about 3,000 to about 20,000. b) Copolymers of N-vinvlpyrrolidone and N-vinylimidazole

The N-vinylimidazole N-vinylpyrrolidone polymers used in the present invention have an average molecular weight range from about 5,000 to about 1,000,000, preferably from about 5,000 to about 200,000. Highly preferred polymers for use in the laundry detergent compositions according to the present invention comprise a polymer selected from N-vinylimidazole N-vinylpyrrolidone copolymers wherein said polymer has an average molecular weight range from about 5,000 to about 50,000; more preferably from about 8,000 to about 30,000; and most preferably from about 10,000 to about 20,000. The average molecular weight range was determined by light scattering as described in Barth H. G. and Mays J. W. Chemical Analysis Vol 113, “Modern Methods of Polymer Characterisation”. Highly preferred N-vinylimidazole N-vinylpyrrolidone copolymers have an aver-age molecular weight range from about 5,000 to about 50,000; more preferably from about 8,000 to about 30,000; most preferably from about 10,000 to about 20,000. The N-vinylimidazole N-vinylpyrrolidone copolymers characterised by having said average molecular weight range provide ex-cellent soil catcher properties. The N-vinylimidazole N-vinylpyrrolidone copolymer of the present invention has a molar ratio of N-vinylimidazole to N-vinylpyrrolidone from about 1 to about 0.2, more preferably from about 0.8 to about 0.3, and most preferably from about 0.6 to about 0.4 c) Polyvinylpyrrolidone

Polyvinylpyrrolidone (“PVP”) having an average molecular weight from about 2,500 to about 400,000 can also be utilised; preferably of average molecular weight from about 5,000 to about 200,000; more preferably from about 5,000 to about 50,000; and most preferably from about 5,000 to about 15,000. Suitable polyvinylpyrrolidones are commercially available from ISP Corporation, New York, N.Y. and Montreal, Canada under the product names PVP K-15 (viscosity molecular weight of 10,000), PVP K-30 (average molecular weight of 40,000), PVP K-60 (average molecular weight of 160,000), and PVP K-90 (average molecular weight of 360,000). Other suitable polyvinylpyrrolidones which are commercially available from BASF include Sokalan HP 165 and Sokalan HP 12; polyvinylpyrrolidones known to persons skilled in the detergent field (see for example EP-A-262,897 and EP-A-256,696). d) Polyvinyloxazolidone

One may also utilise polyvinyloxazolidone as a polymeric soil catcher agent. Said polyvinyloxazolidones have an average molecular weight from about 2,500 to about 400,000; preferably from about 5,000 to about 200,000; more preferably from about 5,000 to about 50,000; and most preferably from about 5,000 to about 15,000. e) Polyvinylimidazole

One may also utilise polyvinylimidazole as polymeric soil catcher agent. Said polyvinylimidazoles have an average molecular weight from about 2,500 to about 400,000; preferably from about 5,000 to about 200,000; more preferably from about 5,000 to about 50,000; and most preferably from about 5,000 to about 15,000. f) Cationic Polymers

Such polymers are those having a cationic group into their polymeric backbone, as shown by the formula:

[P-Catₓ]ₙ, −Zₜ-Caty wherein P represents polymerisable units, Z represents an alkyl, aryl carbonyl ester, ether, amide or amine group, Cat represents cationic groups, preferably including qua-ternised N groups or other cationic units, x=0 or 1, y=0 or 1, t=0 or 1. Preferred cationic polymers are quaternised polyvinylpyridines.

Water insolubility can, in the case of non-cross linked polymers, also be achieved by selecting very high molecular weight range, or by copolymerising, or by varying the de-gree of oxidation if appropriate, depending on the polymer. Polymers which are water soluble, such as those described in U.S. Pat. No. 5,912,221, may be made insoluble if the molecular weight is increased above 400,000. g) Cross-Linked Polymers

Cross-linked polymers are polymers whose backbones are interconnected to a certain degree; these links can be of chemical or physical nature, possibly with active groups on the backbone or on branches; cross-linked polymers have been described in the Journal of Polymer Science, volume 22, pages 1035-1039. In one embodiment, the cross-linked polymers are made in such a way that they form a three-dimensional rigid structure, which can entrap dyes in the pores formed by the three-dimensional structure. In another embodiment, the cross-linked polymers entrap the dyes by swelling. Such cross-linked polymers are described in U.S. Pat. No. 5,912,221.

Thus, a cross-linked polymer has one or more individual molecular chains linked by side branches to adjacent chains. The cross-links can be formed: (a) between already existing linear or branched polymers, (b) during the polymerisation of multi-functional monomers, or (c) during the polymerisation of dimeric monomers with traces of multi-functional monomers. The cross-linking can also be achieved by various means known in the art. For instance, the cross-links can be formed using radiation, oxidation and curing agents, such as divinylbenzene, epichlorohydrin and the like. Preferably, cross-linked polymers for the purpose of this invention are those obtained by cross-linking a water-soluble soil catcher polymer described above with divinyl-benzene (DVB) cross-linking agent during polymerisation of the soil catcher monomer. Cross-linking degree can be controlled by adjusting the amount of divinylbenzene (DVB) cross-linking agent. Preferably, the degree of cross-linking is between about 0.05 percent wt of DVB over soil catcher monomer and about 50 percent of DVB over soil catcher monomer and, more preferably, between about 0.05 percent wt of DVB over soil catcher monomer and about 25 percent wt of DVB over soil catcher monomer. Most preferably, the degree of cross-linking is between about 0.1 percent wt of DVB over soil catcher monomer and about 5 percent wt of DVB over soil catcher monomer. The cross linking forms soil catcher compound particles, at least 90 percent of which by total weight of particles (and more preferably at least about 95 percent) have a dso particle size of at least about 1 mum, preferably at least about 50 mum, and more preferably at least about 75 mum, all as measured in their dry state. The dso particle size is the particle size or weight median particle diameter which 50 percent wt of the particles are larger than, and 50 percent wt are smaller than. It may suitably be determined by mechanical sieving. Most preferably, the cross linking forms soil catcher compounds, at least 90 percent (and more preferably at least about 95 percent) of which have a dso particle size of between about 1 mum and about 5 mm, still more preferably between about 50 mum and about 2500 mum, and yet still more preferably between about 75 mum and about 1500 mum, all as measured in their dry state. Preferably, the cross-linked polymer is a polyamine N-oxide or a quaternised polyamine. The person skilled in the art may conveniently obtain such compounds by oxidising or qua-ternizing cross-linked polyvinylpyridines from Reilly Industries Inc. commercialised under the name Reillex (™) 402 or Reillex (™) 425 by methods known in the art. For instance, but not exclusively, the method described in U.S. Pat. No. 5,458,809 can be used to prepare a polyamine N-oxide of interest from the commercially available compounds given above. An example of quaternised polyamine can also be obtained from Reilly Industries under the commercial name Reillex (™) HPQ.

Super absorbing polymers such as acrylic cross linked polymers are useful within the scope of this patent. Examples are Alcosorb grades from Ciba, Acusol from Rohm AND Haas and Cabloc from Degussa.

Other important polymers are ethylidene norbene polymers, ethylidene norbene/ethylene copolymers, ethylidene nor-bene/propylene/ethylidene ter-polymers.

The soil catcher may be present in the cleaning composition in an amount of 0.01 to 100 percent wt of the composition, preferably from 1 to 90 percent wt, more preferably from 5 to 50 percent wt.

The cleaning composition may also contain additives, such as builders, chelating agents, solvents, enzymes, fragrances, and anti-caking agents, as described in further detail below.

The cleaning composition is preferably in the form of a powder. By “powder” we mean any solid, flowable composition. Thus the powder may, for example, be in the form of granules or agglomerated particles. It may, however, be in the form of a loose agglomeration of particles. The d₅₀ particle size of the particles may range from 0.001 mum to 10 mm, preferably from 0.01 mum to 2 mm, and more preferably from 0.1 mum to 2 mm, for example 1 mum to 1 mm.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, al-kylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosucci-nates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and oleoyl sarcosinates and mixtures thereof.

The composition of all aspects of the present invention may, for example, comprise at least one builder or a combination of them, for example in an amount of from 0.01 to 80 percent wt, preferably from 0.1 to 50 percent wt. Builders may be used as chelating agents for metals, as anti-redeposition agents and/or as alkalis.

Examples of builders are described below:

the parent acids of the monomeric or oligomeric polycar-boxylate chelating agents or mixtures thereof with their salts, e.g. citric acid or citrate/citric acid mixtures are also contemplated as useful builder components.

borate builders, as well as builders containing borate-forming materials than can produce borate under detergent storage or wash conditions can also be used.

iminosuccinic acid metal salts. -polyaspartic acid metal salts.

ethylene diamino tetra acetic acid and salt forms.

water-soluble phosphonate and phosphate builders are useful for this invention. Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium, potassium and ammonium pyrophosphate, sodium, potassium and ammonium pyrophosphate, sodium and potassium orthophosphate, sodium polymeta/phosphate in which the degree of polymerization ranges from 6 to 21, and salts of phytic acid. Such polymers in-elude polycarboxylates containing two carboxy groups, water-soluble salts of succinic acid, malonic acid, (ethyl-enedioxy) diacetic acid, maleic acid, diglycolic acid, tartaric acid, tartronic acid and fumaric acid, as well as the ether carboxylates and the sulfinyl carboxylates.

Polycarboxylates containing three carboxy groups include, in particular, water-soluble citrates, aconitrates and citraconates as well as succinate derivates such as the carboxymethloxysuccinates described in GB-A-I, 379, 241, lac-toxysuccinates described in GB-A-1, 389, 732, and aminosucci-nates described in NL-A-7205873, and the oxypolycarboxylate materials such as 2-oxa-I, 1, 3-propane tricarboxylates de-scribed in GB-A-I, 387, 447.

Polycarboxylate containing four carboxy groups include oxy-disuccinates disclosed in GB-A-I, 261, 829, 1, 1, 2, 2-ethane tetracarboxylates, 1, 1, 3, 3-propane tetracarboxylates and 1, 1, 2, 3-propane tetracarobyxlates. Polycarboxylates containing sulfa substituents include the sulfosuccinate derivatives disclosed in GB-A-I, 398, 421, GB-A-I, 398, 422 and US-A-3, 936448, and the sulfonated pyrolysed citrates described in GB-A-I, 439, 000.

Alicylic and heterocyclic polycarboxylates include cyclopentane-cis, cis, cis-tetracarboxylates, cyclopentadi-enide pentacarboxylates, 2, 3, 4, 5, 6-hexane-hexacarboxy-lates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-I, 425, 343.

Of the above, the preferred polycarboxylates are hydroxy-carboxylates containing up to three carboxy groups per molecule, more particularly citrates.

Suitable polymer water-soluble compounds include the water soluble monomeric polycarboxylates, or their acid forms, homo or copolymeric polycarboxylic acids or their salts in which the polycarboxylic acid comprises at least two car-boxylic radicals separated from each other by not more than two carbon atoms, carbonates, bicarbonates, borates, phosphates, and mixtures of any of the foregoing.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-I, 379,241, lactoxysuccinates described in GB-A-1,389,732, and aminosuccinates described in NL-A-7205873, and the oxypolycarboxylate materials such as 2-oxa-I,I,3-propane tricarboxylates described in GB-A-I, 387, 447.

Polycarboxylate containing four carboxy groups include oxy-disuccinates disclosed in GB-A-I, 261, 829, 1, 1, 2, 2-ethane tetracarboxylates, 1, 1, 3, 3-propane tetracarboxylates and 1, 1, 2, 3-propane tetracarobyxlates. Polycarboxylates containing sulfa substituents include the sulfosuccinate de-rivatives disclosed in GB-A-1, 398, 421, GB-A-1, 398, 422 and US-A-3, 936448, and the sulfonated pyrolysed citrates described in GB-A-I, 439, 000.

Alicylic and heterocyclic polycarboxylates include cyclopentane-cis, cis, cis-tetracarboxylates, cyclopentadi-enide pentacarboxylates, 2, 3, 4, 5, 6-hexane-hexacarboxy-lates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-I, 425, 343.

Of the above, the preferred polycarboxylates are hydroxy-carboxylates containing up to three carboxy groups per molecule, more particularly citrates.

More preferred polymers are homopolymers, copolymers and multiple polymers of acrylic, fluorinated acrylic, sul-fonated styrene, maleic anhydride, metacryl.ic, iso-butylene, styrene and ester monomers.

Examples of these polymers are Acusol supplied from Rohm AND Haas, Syntran supplied from Interpolymer and the Versa and Alcosperse series supplied from Alco Chemical, a National Starch AND Chemical Company.

The parent acids of the monomeric or oligomeric polycar-boxylate chelating agents or mixtures thereof with their salts, e.g. citric acid or citrate/citric acid mixtures are also contemplated as useful builder components.

Examples of bicarbonate and carbonate builders are the alkaline earth and the alkali metal carbonates, including so-dium and calcium carbonate and sesqui-carbonate and mixtures thereof. Other examples of carbonate type builders are the metal carboxy glycine and metal glycine carbonates.

In the context of the present application it will be appreciated that builders are compounds that sequester metal ions associated with the hardness of water, e.g. calcium and magnesium, whereas chelating agents are compounds that sequester transition metal ions capable of catalysing the degradation of oxygen bleach systems. However, certain compounds may have the ability to do perform both functions.

Suitable chelating agents to be used herein include chelating agents selected from the group of phosphonate chelating agents, amino carboxylate chelating agents, polyfunction-ally-substituted aromatic chelating agents, and further chelating agents like glycine, salicylic acid, aspartic acid, glutamic acid, malonic acid, or mixtures thereof. Chelating agents when used, are typically present herein in amounts ranging from 0.01 to 50 percent wt of the total composition and preferably from 0.05 to 10 percent wt.

Suitable phosphonate chelating agents to be used herein may include ethydronic acid as well as amino phosphonate compounds, including amino alkylene poly (alkylene phosphonate), alkali metal ethane 1-hydroxy diphosphonates, ni-trilo trimethylene phosphonates, ethylene diamine tetra me-thylene phosphonates, and diethylene triamine penta methylene phosphonates. The phosphonate compounds may be present either in their acid form or as salts of different cations on some or all of their acid functionalities. Preferred phosphonate chelating agents to be used herein are diethyl-ene triamine penta methylene phosphonates. Such phosphonate chelating agents are commercially available from Monsanto under the trade name DEQUEST ™.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisul-fobenzenes such as 1, 2-dihydroxy-3, 5-disulfobenzene.

A preferred biodegradable chelating agent for use herein is ethylene diamine N, N′-disuccinic acid, or alkali metal, or alkaline earth, ammonium or substituted ammonium salts thereof or mixtures thereof. Ethylenediamine N, N¹-disuccinic acids, especially the (S, S) isomer have been extensively described in U.S. Pat. No. 4,704,233, Nov. 3, 1987, to Hartman and Perkins. Ethylenediamine N,N′-disuccinic acid is, for instance, commercially available under the tradename ssEDDS ™ from Palmer Research Laboratories.

Suitable amino carboxylates to be used herein include ethylene diamine tetra acetates, diethylene triamine pentaace-tates, diethylene triamine pentaacetate (DTPA), N-hy-droxyethylethylenediamine triacetates, nitrilotri-acetates, ethylenediamine tetrapropionates, triethylenetetraamine-hexa-acetates, ethanol-diglycines, propylene diamine tet-racetic acid (PDTA) and methyl glycine diacetic acid (MGDA), both in their acid form, or in their alkali metal, ammonium, and substituted ammonium salt forms. Particularly suitable amino carboxylates to be used herein are diethylene triamine penta acetic acid, propylene diamine tet-racetic acid (PDTA) which is, for instance, commercially available from BASF under the trade name Trilon FS ™ and methyl glycine di-acetic acid (MGDA).

The cleaning compositions of all aspects of the invention may also comprise fillers. Examples of fillers are sodium chloride, bentonite, zeolites, citrates, talc and metal sulfate salts such as sodium, calcium and aluminium sul-phates. They can be used at a level from 0.01 to 60 percent wt, preferably between 0.1 to 30 percent wt.

The cleaning compositions of all aspects of the invention may also comprise a solvent. Solvents can be used for pre-sent invention in amounts from 0.01 to 30 percent wt, preferably in amounts of 0.1 to 3 percent wt. The solvent constituent may include one or more alcohol, glycol, acetate, ether acetate, glycerol, polyethylene glycol with molecular weights ranging from 200 to 1000, silicones or glycol ethers. Ex-emplary alcohols useful in the compositions of the invention include C2-C8 primary and secondary alcohols which may be straight chained or branched, preferably pentanol and hexanol.

Preferred solvents for the invention are glycol ethers. Examples include those glycol ethers having the general structure R₃—O—[CH₂—CH (R)—(CH₂)-0]ₙ—H, wherein Rₐ is Ci_{—2}o al-kyl or alkenyl, or a cyclic alkane group of at least 6 carbon atoms, which may be fully or partially unsaturated or aromatic; n is an integer from 1 to 10, preferably from 1 to 5; and each R is selected from H or CH₃. Specific and preferred solvents are selected from propylene glycol methyl ether, dipropylene glycol methyl ether, tripropylene glycol methyl ether, propylene glycol n-propyl ether, eth-ylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and, especially, propylene glycol phenyl ether, ethylene glycol hexyl ether and di-ethylene glycol hexyl ether.

The composition may, for example, comprise one enzyme or a combination of them, for example in an amount of from 0.01 to 10 percent wt, preferably from 0.1 to 2 percent wt. Enzymes in granular form are preferred. Examples of suitable enzymes are proteases, modified proteases stable in oxidisable conditions, amylases, lipases and cellulases.

Additional, optional, ingredients, selected from a list comprising fragrance, anticaking agent such as sodium xylene sulfonate and magnesium sulfate and dye, may be present, each at levels of up to 5 percent wt, preferably less then 1 percent wt.

Stain and/or dye catcher systems useful for the present invention may be mixed to the cleaning composition in an amount ranging from 0.1 to 50 percent wt, preferably from 1 to 30 percent wt. They can be optionally also added as filler to the enclosing wall in an amount ranging from 0.1 to 60 percent wt, more preferably from 1 to 30 percent wt.

The product of the present invention may also include dis-persing or suspending agents that may be released into the wash to aid the soil being bound to the soil catcher. Such agents may be deposited on the enclosing wall of the product, or contained in the enclosing wall with or as part of the cleaning composition. Examples of such agents include carboxy methyl cellulose and acrylic maleic copolymers or acrylic polymers. Such agents may be used in an amount of 0.01 to 30 percent wt, preferably 0.1 to 10 percent wt of the cleaning composition.

The present invention also provides a method of cleaning laundry in a laundry washing machine, which comprises adding a composition as defined above to the washing machine and conducting the wash.

1. A laundry composition comprising:
a) about 0.1 wt % to about 20 wt % of an anionic soap surfactant,
b) 0.5 wt % to 2.5 wt % of an alkyl sulphate surfactant,
c) 0.1 wt % to 2 wt % of a nonionic surfactant,
d) 0.1 wt % to 2 wt % of a dispersing or suspending agent,
e) 2 wt % to 12 wt % to a source of active oxygen.

2. (canceled)

3. (canceled)

4. The laundry composition of claim 1, comprising:
a) about 2 wt % to about 10 wt % of an anionic soap surfactant.

5. The laundry composition of claim 4, comprising:
a) about 4 wt % to about 8 wt % of an anionic soap surfactant.

6. The laundry composition of claim 1, comprising:
b) about 1.5 wt % of an alkyl sulphate surfactant.

7. The laundry composition of claim 1, comprising:
c) about 1 wt % of a nonionic surfactant.

8. The laundry composition of claim 1, comprising:
d) about 1 wt % of carboxy methyl cellulose.

9. The laundry composition of claim 1, comprising:
e) about 7 wt % of active oxygen.

10. The laundry composition of claim 1, further comprising:
f) 0.1 wt % to 40 wt % of a peracid precursor.

11. The laundry composition of claim 1, further comprising:
g) 0.1 wt % to 80 wt % of a filler.

12. The laundry composition of claim 1, further comprising:
h) 4 wt % to 30 wt % of a zeolite.

13. The laundry composition of claim 1, further comprising:
i) 0.01 wt % to 90 wt % of a soil catcher.

14. The laundry composition of claim 1, further comprising:
j) 0.01 wt % to 80 wt % of a builder.

15. The laundry composition of claim 1, further comprising:
k) 0.01 wt % to 30 wt % of a solvent.

16. The laundry composition of claim 1, further comprising:
l) 0.01 wt % to 10 wt % of an enzyme.

17. The laundry composition of claim 1, further comprising:
m) 0.1 wt % to 50 wt % of a stain and/or dye catcher system.

18. The laundry composition of claim 17, wherein the dispersing or suspending agent is carboxy methyl cellulose, an acrylic polymer or an acrylic maleic copolymer.

19. The laundry composition of claim 1, further comprising:
water;
a filler;
a zeolite;
a copolymer.

20. A method of preparing the laundry composition of claim 19, the method comprising the steps of:
I. forming a slurry of certain elements of the composition;
II. feeding the slurry to a tower spray apparatus; and
III. optionally (post) adding of elements of the composition;
wherein the slurry formation comprises the following composition:
a) water;
b) an anionic soap surfactant;
c) a filler;
d) a zeolite;
e) a copolymer;
wherein during mixing of the slurry the pH during mixing is maintained below 8.5 and the working temperature is maintained between 50° C.-60° C.

21. The method of claim 20 wherein the slurry formation comprises the following composition:
a) about 32 wt % of water;
b) about 5.5 wt % of the anionic soap surfactant;
c) about 45 wt % of the filler;
d) about 20 wt % of the zeolite;
e) about 5.5 wt % of the copolymer.

22. The method of claim 20, wherein components (a) to (e) are added to the slurry preparation vessel in the following sequential order:
a) water;
b) the anionic soap surfactant;
c) the filler;
d) the zeolite;
e) the copolymer.
